(19) United States
(12) Patent Application Publication
(10) Pub. No.: US 2013/0323292 A1
(43) Pub. Date: Dec. 5, 2013

(54) Clog Resistant Insect Control Formulations Containing Pyrethrin, An Acetylenic Compound, And A Hydrocarbon Diene

(71) Applicants: Lina Long, Mount Prospect, IL (US); Brian W. Anderson, Racine, WI (US); Gerald W. Cummings, Pleasant Prairie, WI (US); Francis J. Randall, Racine, WI (US); Jamie T. Huynh, Franklin, WI (US); Deliang Shi, Kenosha, WI (US)

(72) Inventors: Lina Long, Mount Prospect, IL (US); Brian W. Anderson, Racine, WI (US); Gerald W. Cummings, Pleasant Prairie, WI (US); Francis J. Randall, Racine, WI (US); Jamie T. Huynh, Franklin, WI (US); Deliang Shi, Kenosha, WI (US)

(21) Appl. No.: 13/486,325

(22) Filed: Jun. 1, 2012

(51) Int. Cl. A01N 53/10; A01N 25/10; A01P 7/04; A01N 25/08

(52) U.S. Cl. 424/411; 514/531

(57) ABSTRACT

Disclosed are pyrethrin-based insect control formulations which have been formulated to reduce wick clogging in dispensers which use heaters to drive an insect control active from the wick. Pyrethrum extract is mixed with an acetylenic compound, such as prallethrin or 3,5-dimethylhex-1-yn-3-ol, and a terminal diene compound such as myrcene or 1,3 hexadiene. Wick clogging side effects from using the pyrethrum are thereby suppressed.

### CROSS-REFERENCE TO RELATED APPLICATIONS

Not applicable

### STATEMENT REGARDING FEDERALLY SPONSORED RESEARCH/DEVELOPMENT

Not applicable

### BACKGROUND OF THE INVENTION

The present invention relates to devices that dispense a pyrethrin-based insect control formulation from a porous wick. More particularly, it relates to providing formulations (and formulation impregnated wicks) for use with such devices, where the formulations include a mix of pyrethrin, an acetylenic compound, and a hydrocarbon diene, and as a result reduce the tendency of pyrethrin-based formulations to clog the wick.

Pyrethrum is an insecticide obtainable from a natural plant source. It is typically extracted from a chrysanthemum plant in a form that contains pyrethrin I (see FIG. 1), pyrethrin II, cinerin I, cinerin II, jasmolin I and jasmolin II, usually with some impurities. In some cases one or more of pyrethrin I or II is isolated from the extract, and used separately. More often, the overall pyrethrum extract is used.

Chrysanthemum plants can be grown and harvested in an environmentally friendly (e.g. sustainable) manner, and pyrethrum extract can be obtained from them at relatively low cost. Also, because it is obtained from an essentially natural source, pyrethrum extract has a somewhat wider regulatory and public perception acceptance than a number of more synthetic insect control ingredients do.

To dispense pyrethrum/pyrethrins one typically dissolves the extract in a solvent (e.g. an isoparaffinic hydrocarbon material such as an Isopar), places the resulting solution in a reservoir such as a bottle, extends a porous wick through a cap of the bottle into the liquid, slowly attracts the active/solvent mix out of the reservoir via the wick to an exposed end of the wick, and then drives an active/solvent mix off the exposed end of the wick into the environment (e.g. most typically using a heater system such as that of U.S. Pat. No. 5,647,053). The heater system could be supplemented with a blower if desired (e.g. compare the fan system of U.S. Pat. No. 7,444,833).

Unfortunately, pyrethrum extract impurities tend to react (largely through oxidation and polymerization reactions) to form materials that can clog a dispensing wick. This is in part due to impurities typically found in the extract being oxidized and/or polymerized to clogging materials, and in part because some pyrethrum extract core active components are susceptible to unwanted oxidation/polymerization, again leading to formation and deposition of nonvolatile components in the evaporation zone of the wick that cause wick clogging.

Wick clogging reduces the effectiveness of this type of dispensing device over time, eventually reducing the air release rate of pyrethrin from device, and consequently reducing mosquito repellency. As a result, some consumers may not be satisfied with the performance of conventional pyrethrum-impregnated wicks absent further improvements.

Prallethrin (a/k/a ETOC) has a structure as depicted in FIG. 2. It is a synthetically produced pyrethroid-based insecticide. It has previously been used in wick dispensers for mosquito and other insect control products.

Myrcene has a formula as depicted in FIG. 3. It is a component of a number of essential oils.

Surfynol 61 has a formula as depicted in FIG. 4. It is a surfactant widely used in paints. Both prallethrin and surfynol 61 are acetylenic in nature in that they have a terminal HC≡C moiety.

In any event, a need exists to address the pyrethrin-related wick clogging concern, without introducing other unacceptable disadvantages (while maintaining the advantages of using pyrethrum).

### BRIEF SUMMARY OF THE INVENTION

In one aspect the invention provides an insect control formulation. It contains an insect control ingredient comprising pyrethrin (e.g. a pyrethrum extract containing one or more of pyrethrin I and II), a solvent that the pyrethrin is carried in (e.g. an isoparaffinic hydrocarbon such as Isopar), a compound having a C≡C moiety (most preferably the compound has a terminal HC≡C— moiety), and a hydrocarbon having the following moiety:

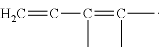

The hydrocarbon may be linear or branched, and may have more than one such moiety (e.g. such a group at opposed terminal ends). The term “diene” is being used hereafter with respect to such hydrocarbons to mean a compound having at least two carbon-carbon double bonds in the specified arrangement, even if there are more than two. By “hydrocarbon” it is intended that the compound only have hydrogen and carbon. 1,3 conjugated diener are particularly preferred such as myrcene and 1,3 hexadiene. Prallethrin and 3,5-dimethylhex-1-yn-ol are suitable acetylenic compounds. Other suitable acetylenic compounds preferably have less than twenty hydrocarbons.

It is most preferred that the pyrethrin containing ingredient be about 1 to 10% by weight of the formulation (e.g. about 4%), the diene be about 0.1 to 4% by weight of the formulation, the solvent be about 80 to 95% by weight of the formulation, the acetylenic compound be about 0.1 to 2% by weight of the formulation, and other ingredients (e.g. an antioxidant) be the remainder.

In some forms the pyrethrin containing ingredient is pyrethrum extract, and the diene has between 5 and 20 carbons (and is a fragrance). For example, the diene may be an acyclic monoterpene such as myrcene, and the formulation may include an antioxidant or radical chain stopper such as dilauryl thiodipropionate, butylated hydroxytoluene or 2,2′-methylenebis(6-tert-butyl-4-methylphenol).

In other aspects the invention provides a wick for dispensing such an insect control formulation. There is a porous wick body and such an insect control formulation positioned in pores of the wick body. One can use a sintered glass material for the wick body (e.g. available from Porex). Alternatively, other inert porous wick substrates can be used for the body such as nylons. While it is also possible to use wicks made from wood material, that is not preferred as wood wicks are exposed to conditions during manufacture that may produce oxygenated species that could accelerate the degradation of the active.

By combining such an acetylenic compound (particularly those with a terminal carbon/carbon triple bond moiety), and a diene of the present invention, side reactions responsible for creating clogging compounds from pyrethrum extract can be synergistically suppressed. This suppression effect can be further enhanced where an antioxidant or radical chain stopper is also used.

The insect control formulations of the present invention can be initially positioned in pores of a porous wick by causing the wick to attract the formulation from a reservoir (by capillary attraction). The wick can project down into the insecticidal formulation in the reservoir, and also extend externally upward/outward. The external portion of the wick can then be positioned next to a means for driving the active off the wick (e.g. most preferably a heater).

The invention thereby renders the use of pyrethrin (especially natural extract pyrethrum containing pyrethrins) more practical as a substitute for synthetic pyrethroids when controlling mosquitoes, and also thereby opens up the possibility of providing a more natural insect control formulation.

The foregoing and other advantages of the present invention will be apparent from the following description. As these embodiments are merely illustrative, they are not intended to represent the full scope of the invention. Thus, reference should therefore be made to the claims herein for interpreting the scope of the invention.

### DRAWINGS

FIG. 1 depicts the structure of pyrethrin I, a preferred component of the formulations of the present invention;

FIG. 2 depicts the structure of prallethrin, one of the preferred acetylenic components of the present invention;

FIG. 3 depicts the structure of myrcene, one of the preferred diene components of the present invention;

FIG. 4 depicts the structure of surfynol 61, another of the preferred acetylenic components of the present invention;

FIG. 5 is a graph comparing the emission rates of a standard pyrethrin-based formulation with that of a formulation of the present invention, over time;

FIG. 6 is a graph showing emission rates of similar formulations (but with only one of prallethrin or myrcene), over time; and

FIG. 7 is a graph, among other things, confirming suitability of surfynol 61 plus myrcene.

### DETAILED DESCRIPTION OF THE PREFERRED EMBODIMENTS

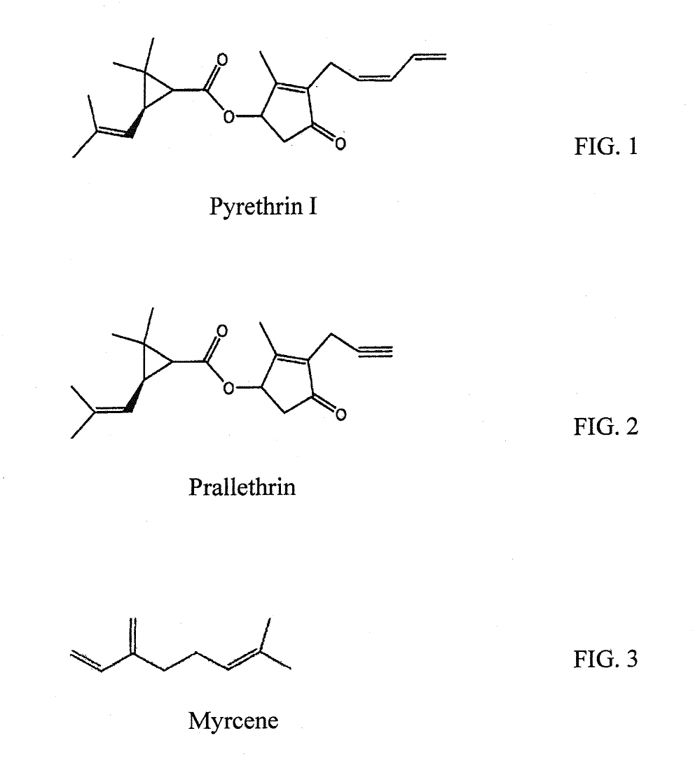

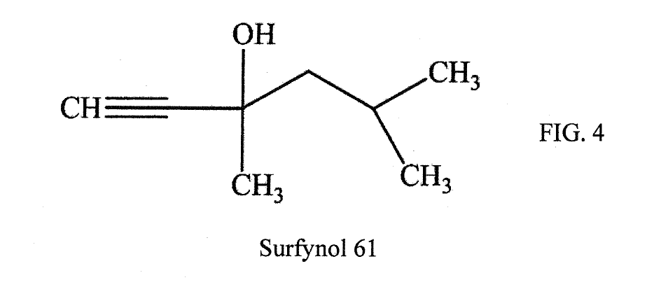

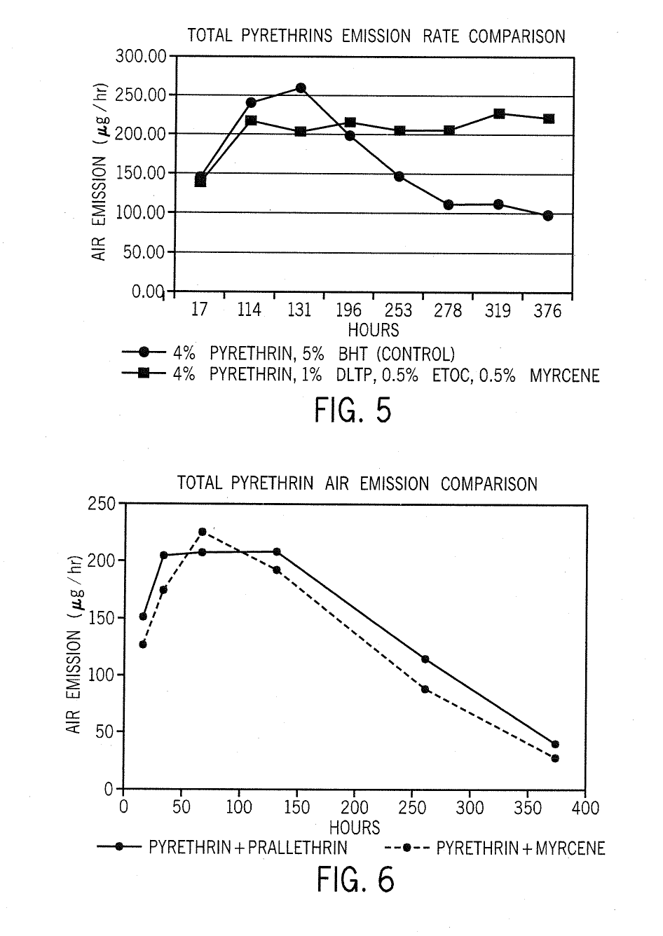

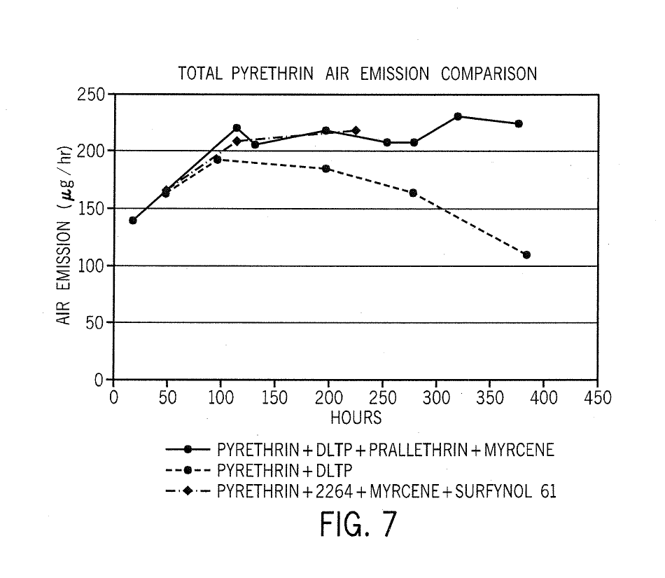

A test formulation contained 8% of a 50% solution of pyrethrum extract (4% active), 1% dilauryl thiodipropionate antioxidant, 0.5% prallethrin/ETOC (see FIG. 1), 0.5% myrcene (see FIG. 1) and 90% Isopar V isoparaffinic hydrocarbon. This was compared, as shown in FIG. 5, with a similar formulation, but with the LTDP only.

In other formulations we evaluated 0.5% of surfynol 61 instead of 0.5% prallethrin, and evaluated the effectiveness of an alternative antioxidant.

We have also successfully tested use of surfynol 61 in combination with 1,3 hexadiene.

In our tests, a sintered glass wick (or a nylon wick) was used and the resulting test showed similar results (as compared to the control) for about 200 hours, followed by a drop off in effectiveness in the standard control thereafter. Note that even after 200 hours air emission rates remained stable for the formulation of the present invention.

As shown in FIG. 6, when one creates a formulation similar to the FIG. 5 formulation of the present invention, but with only one of myrcene or prallethrin, wick clogging becomes significant after 200 hours. Thus, the combination of the diene and acetylenic compounds were important in creating the synergistic result.

Standard formulations were also tested for repellency against with those in which myrcene, prallethrin (or surfynol 61), and pyrethrin were used and it was noted that relative knockdown times improved with the addition of the diene and acetylenic compounds of the present invention.

Without being limited to any particular theory, it is believed that the combination of the diene (particularly conjugated terminal diene) and acetylenic (particularly terminal acetylenic) compounds inhibits the oxidation of the impurities in pyrethrum and also minimizes degradation of pyrethrins. Both mechanisms lead to the creation of fewer materials capable of clogging a wick.

Because only small amounts of the acetylenic compounds and dienes are needed for this effect, the present invention efficiently reduces pyrethrin degradation, extends wick life and effectiveness, and also renders the formulation more “natural”. This is achieved without compromising insect control effectiveness.

While preferred embodiments of the present invention have been described above, it should be appreciated that there are numerous other embodiments within the spirit and scope of this disclosure. For example, it is also proposed that one or more of the following dienes replace myrcene or 1,3 hexadiene: 1,3 heptadiene, 1,3 octadiene and 1,3 decadiene. Also, the diene need not be linear, and may have a similar moiety at more than one or two locations. Regardless, the invention is not to be limited to just the specific embodiments shown or described.

### INDUSTRIAL APPLICABILITY

Provided herein are improved insect control formulations, and wicks for delivering them.

All documents cited in this document are, in relevant part, incorporated herein by reference. The citation of any document is not to be construed as an admission that it is prior art with respect to the present invention.

1. An insect control formulation comprising:
an insect control ingredient comprising pyrethrin;
a solvent that the ingredient is carried in;
a compound having a C≡C moiety; and
a hydrocarbon which is at least 0.1% by weight of the formulation, said hydrocarbon having the following moiety

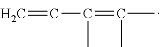

2. The insect control formulation of claim 1, wherein the compound has a terminal HC≡C— moiety.

3. The insect control formulation of claim 2, wherein the compound is selected from the group consisting of prallethrin and 3,5-dimethylhex-1-yn-3-ol.

4. The insect control formulation of claim 1, wherein the ingredient is pyrethrum extract.

5. The insect control formulation of claim 1, wherein the hydrocarbon has between 5 and 20 carbons.

6. The insect control formulation of claim 1, wherein the hydrocarbon is a fragrance.

7. The insect control formulation of claim 1, wherein the hydrocarbon is a monoterpene.

8. The insect control formulation of claim 1, wherein the hydrocarbon is myrcene.

9. The insect control formulation of claim 1, wherein the hydrocarbon is 1,3 hexadiene.

10. The insect control formulation of claim 1, wherein the solvent is an isoparaffinic hydrocarbon solvent.

11. The insect control formulation of claim 1, further comprising a material selected from the group consisting of dilauryl thiodipropionate, butylated hydroxytoluene and 2,2′-methylenebis(6-tert-butyl-4-methylphenol).

12. A wick for dispensing an insect control formulation, comprising:
a porous wick body;
an insect control formulation positioned in pores of the wick body, the formulation comprising:
an insect control ingredient comprising pyrethrin;
a solvent that the ingredient is carried in;
a compound having a C≡C moiety; and
a hydrocarbon having the following moiety

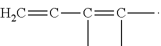

13. The wick of claim 12, wherein the compound has a terminal HC≡C— moiety.

14. The wick of claim 12, wherein the hydrocarbon has between 5 and 20 carbons.

15. The wick of claim 12, wherein the porous wick body comprises sintered glass and/or nylon.

16. The insect control formulation of claim 1, wherein the solvent is at least 80% by weight of the formulation.
